(19) United States
(12) Patent Application Publication
(10) Pub. No.: US 2012/0197774 A1
(43) Pub. Date: Aug. 2, 2012

(54) Systems, Methods, and Media for Generating and Sending Indications of Interest in Trading Systems

(76) Inventors: Edward F. Gallagher, Westfield, NJ (US); Peter J. Coleman, JR., Fair Haven, NJ (US); Joseph Virgilio, Pound Ridge, NY (US); Peter S. Gargone, New York, NY (US)

(21) Appl. No.: 13/016,853

(22) Filed: Jan. 28, 2011

(51) Int. Cl. G06Q 40/00

(52) U.S. Cl. 705/37

(57) ABSTRACT

Systems, methods, and media for generating and sending indications of interest in trading systems are provided. In some embodiments, systems for generating and sending indications of interest in trading systems are provided, the systems comprising: at least one hardware processor that: determines whether an order is blocked from inclusion in an indication of interest; determines whether the order is marketable; generates the indication of interest so that it includes at least a portion of the order when the order is determined to not be blocked and the order is marketable; determines whether the indication of interest is blocked from being sent to a destination; and sends the indication of interest to the destination when the indication of interest is determined to not be blocked from being sent to the destination.

### TECHNICAL FIELD

The disclosed subject matter relates to systems, methods, and media for generating and sending indications of interest in trading systems.

### BACKGROUND

The capital markets are essential components of the world's economies. Through these markets, among other things, companies and governments can raise money to support their operations by selling securities (such as stocks and bonds) to investors.

Liquidity, which is the availability of securities to be bought or sold, is an important aspect of any capital market. Before a security can be sold, there must be someone willing to buy it. Likewise, before a security can be bought, there must be someone willing to sell it. Thus, markets attempt to increase liquidity by encouraging participants to disclose their willingness to buy or sell a security.

An indication of interest (IOI) is a mechanism through which a market participant can indicate its willingness to buy or sell a security. As its name suggests, an IOI indicates to other participants in a market that a participant is interested in buying or selling a given security.

Typically, IOIs are generated manually by a trader. These IOIs will then be sent to one or more indicated market places. Because of the need to manually control IOIs, the information contained therein can be incomplete or out of date. Similarly, because IOIs are typically manually generated, the IOIs can be misused to probe the interest of others by sending out a false IOI to see if anyone will respond with an order to trade a corresponding security.

Accordingly, it is desirable to provide new systems, methods, and media for generating and sending indications of interest in trading systems.

### SUMMARY

Systems, methods, and media for generating and sending indications of interest in trading systems are provided. In some embodiments, systems for generating and sending indications of interest in trading systems are provided, the systems comprising: at least one hardware processor that: determines whether an order is blocked from inclusion in an indication of interest; determines whether the order is marketable; generates the indication of interest so that it includes at least a portion of the order when the order is determined to not be blocked and the order is marketable; determines whether the indication of interest is blocked from being sent to a destination; and sends the indication of interest to the destination when the indication of interest is determined to not be blocked from being sent to the destination.

In some embodiments, methods for generating and sending indications of interest in trading systems are provided, the methods comprising: determining, using at least one hardware processor, whether an order is blocked from inclusion in an indication of interest; determining, using at least one hardware processor, whether the order is marketable; generating, using at least one hardware processor, the indication of interest so that it includes at least a portion of the order when the order is determined to not be blocked and the order is marketable; determining, using at least one hardware processor, whether the indication of interest is blocked from being sent to a destination; and sending, using at least one hardware processor, the indication of interest to the destination when the indication of interest is determined to not be blocked from being sent to the destination.

In some embodiments, computer-readable media containing computer-executable instructions that, when executed by a processor, cause the processor to perform a method for generating and sending indications of interest in trading systems are provided, the method comprising: determining whether an order is blocked from inclusion in an indication of interest; determining whether the order is marketable; generating the indication of interest so that it includes at least a portion of the order when the order is determined to not be blocked and the order is marketable; determining whether the indication of interest is blocked from being sent to a destination; and sending the indication of interest to the destination when the indication of interest is determined to not be blocked from being sent to the destination.

### BRIEF DESCRIPTION OF THE DRAWINGS

FIG. 1 is a block diagram of an example system for generating IOIs in accordance with some embodiments.

FIG. 2 is a diagram of an example process for including order size in an IOI in accordance with some embodiments.

FIG. 3 is a diagram of an example process for sending IOIs to one or more destinations in accordance with some embodiments.

FIG. 4 is an illustration of an example user interface for controlling the generation of IOIs based on orders in accordance with some embodiments.

FIG. 5 is an illustration of an example client tab of the user interface of FIG. 4 in accordance with some embodiments.

### DETAILED DESCRIPTION

Systems, methods, and media for generating and sending indications of interest in trading systems are provided.

In some embodiments, such systems, methods, and media can be used to distribute IOIs across large numbers of destination and provide the flexibility to customize the type of IOIs sent to each destination, the refresh rate at which those IOIs are updated, and threshold parameters for each destination that control when those IOIs are initially sent. These IOIs can be based on size from different orders from different sources in some embodiments.

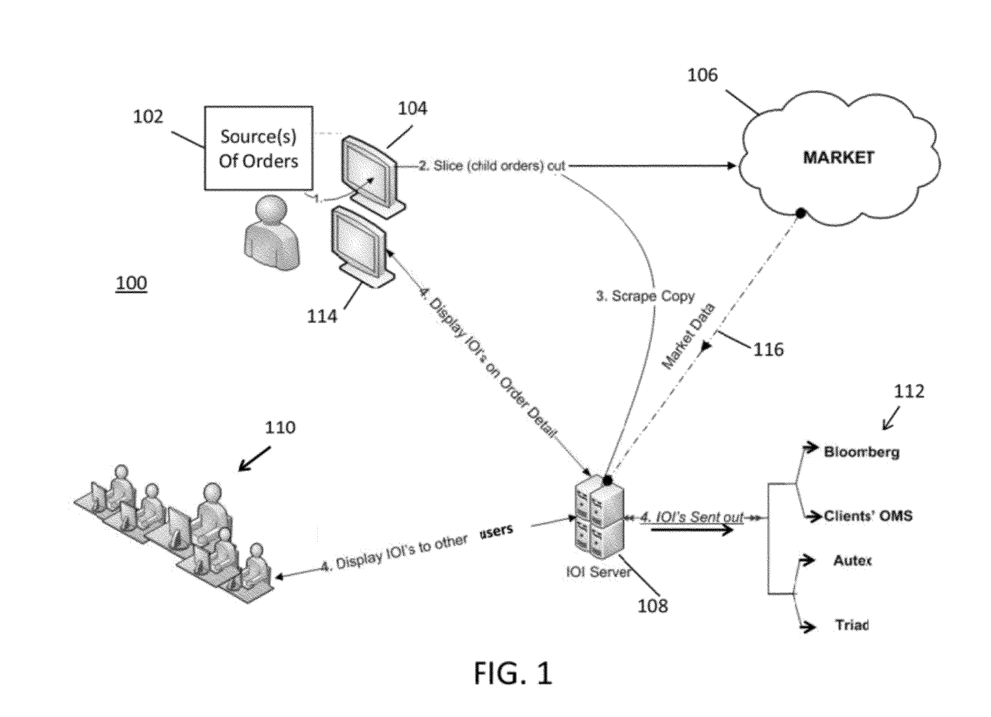

Turning to FIG. 1, an example of a system 100 for generating IOIs in accordance with some embodiments is illustrated. As shown, orders may be received from one or more sources of orders 102. Sources of orders 102 can be any suitable systems for receiving orders. For example, source of orders 102 can be an order management system, an automated trade generation system (e.g., an algorithmic trading system), an order entry system (e.g., for manually typing in orders received via telephone or any other communication system), an interface to another system, etc.

Some or all of these orders may be transferred to an order management system 104 that controls the placing of orders to a market 106. Order management system 104 can be any suitable order management system, and market 106 can be any suitable destination for orders (e.g., such as open markets, dark pools, electronic liquidity providers, etc.).

In many instances, orders are placed to markets in “slices.” A slice can be a portion of an order that is sized to quickly execute the order while not substantially impacting the market price for the security corresponding to the order. For example, if a participant wants to execute a very large buy order in a security, and counterparties become aware of this desire, the price being asked for by the counterparties is likely to increase. Thus, placing a very large buy order could end up driving up the price in the security. By placing smaller slices of an order (a sub-order), a participant can hide the fact that each slice (or sub-order) is being made by the same party. At the same time, however, the participant may also want to minimize the number of sub-orders so as to get the trade executed quickly. Thus, a careful selection of the size of the order can be important.

As shown in FIG. 1, slices of an order can be sent from order management system 104 to market 106. As these slices are sent, data reflecting these slices can be “scraped” (or copied) to an IOI server 108. The IOI server can be any suitable mechanism (as further described below) for controlling the generation of IOIs.

In response to receiving this data reflecting slices of orders, IOI server 108 can construct IOIs, send the IOIs out to one or more destinations 112 (e.g., BLOOMBERG, clients' order management systems (OMSs), AUTEX, TRIAD, etc.). The IOI can also be displayed on a display 114 of one or more traders corresponding to one or more sources of the IOI. The IOI can further be displayed on displays 110 of other traders (e.g., on the same trading floor as the traders corresponding to the one or more sources of the IOI).

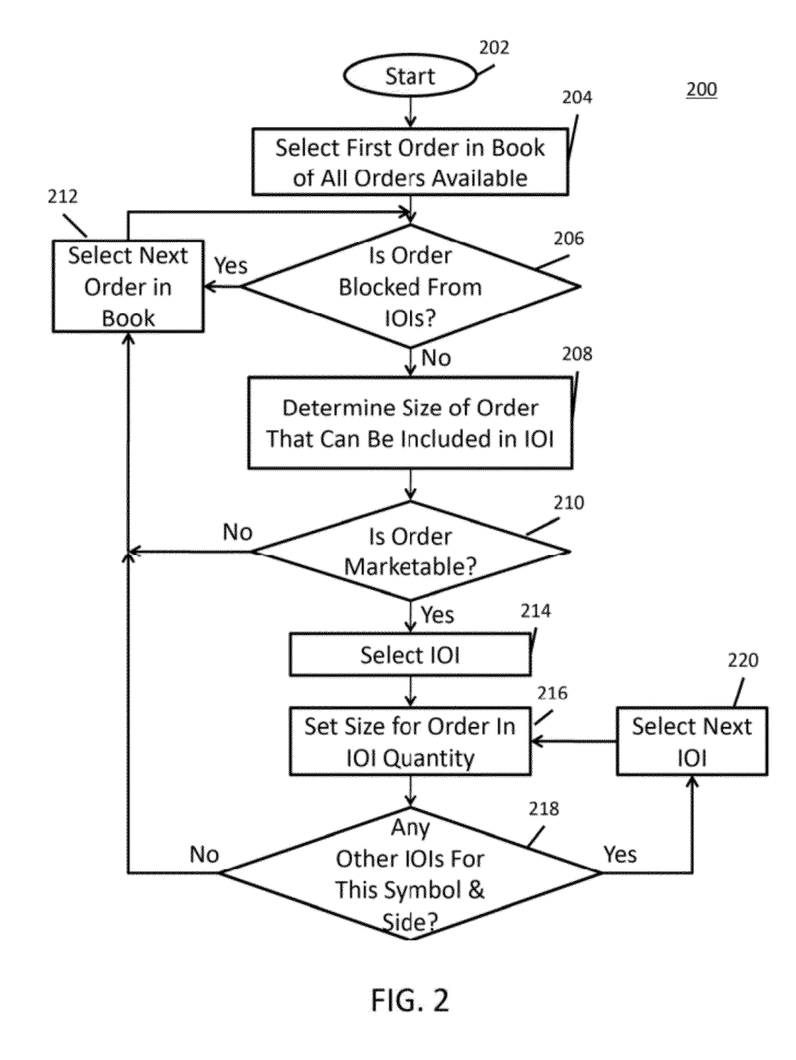

Turning to FIG. 2, an example process 200 for including order size in an IOI is shown. Such a process can be performed in IOI server 108 of FIG. 1. As illustrated, after process 200 begins at 202, the process can select the first order in a book of all orders available at 204. The book of all orders available may be a compilation of the data reflecting slices of orders (i.e., sub-orders) received by IOI server 108. The first order selected from such a book can be selected in any suitable manner. For example, the first order can be selected based on the age of the order, the symbol of the order, the size of the order, etc.

Next, at 206, process 200 can determine whether the order is blocked from inclusion in an IOI. An order can be blocked from inclusion in an IOI for any suitable reason. For example, a party involved with the order can designate that the order is not to be included in an IOI. As another example, a party involved with the order can designate that the corresponding symbol and/or side is not to be included in an IOI. As yet another example, a party involved with the order can designated that the party (or another party involved with the order) is not to be included in an IOI. If it is determined that the order is to be blocked from inclusion in an IOI, then process 200 can select the next order in the book at 212 and loop back to 206. The next order can be selected on any suitable basis.

Otherwise, if the order is determined to not be blocked at 206, then process 200 can determine the size of the order to be included in the IOI at 208. The size can be determined on any suitable basis. For example, in some embodiments, a current working quantity for an order can be used to determine the potential quantity to be contributed to a consolidated IOI (i.e., an IOI whose size is made up from contributions by multiple orders) in a given, symbol and side by that order. The working quantity of the order, and hence the quantity to be contributed to a consolidated IOI, can be updated in near real-time based on slices of the order being sent to the market and executions for those slices returning from the market. After receiving an initial order, the working quantity for that order can be automatically increased as portions of the order are sliced into the market and then automatically reduced as executions for those slices come back into the system. In some embodiments, the quantity corresponding to certain slices may be excluded from the quantity to be contributed to a consolidated IOI when those slices are being posted to certain market destinations, such as an ADV algorithm which may work an order over the entire day or a portion of time, for example.

In some embodiments, a configurable time threshold can be used on an initial slice of an order to introduce a wait period before the automated working quantity of an order can be included in a consolidated IOI. In this way, the working quantities of orders which are quickly filled can be prevented from being included in a consolidated IOI and then immediately removed, while also providing one or more traders with a window of time to evaluate the initial quantity set for an order that is suitable for inclusion in an IOI before it is distributed to various destinations.

In some embodiments, a trader can manually set the quantity of one or more orders that are to be included in a consolidated IOI for a given symbol and side and designate the manually set quantity as the starting quantity to be included in the consolidated IOI. As portions of these orders are then executed, the quantity included in the consolidated IOI can be reduced by the quantity executed.

Next, at 210, process 200 can determine, for a limit order, whether the order is marketable. In some embodiments, real-time market data 116 (FIG. 1) can be used to determine if an order is marketable. For example, a limit order can be considered to be marketable when its limit price is equal to or better than (i.e., lower when selling, and higher when buying) the market for the corresponding symbol and side. Market orders can be automatically determined to be marketable.

If an order is determined to not be marketable at 210, process 200 can branch to 212 to select the next order in the book and then loop back to 206.

Otherwise, if the order is determined to be marketable at 210, an IOI for the order can next be selected at 214. An IOI for an order can be selected based on symbol, side, and any other suitable basis. For example, in some embodiments, only a single IOI may exist for a symbol and side, in which case this IOI can be selected at 214. As another example, in some embodiments, multiple IOIs can exist for the same symbol and side (e.g., one for each of multiple destination groups), and one or more of these IOIs can be selected based on permissible destinations designated for the order.

in some embodiments, if an IOI does not yet exist for an order, then the IOI can be created at 214.

Next, at 216, process 200 can set the size for the order in the IOI. In some embodiments, setting the size can be simply copying the size determined at 208 into the IOI (which can be achieved by setting the size in the IOI or by adding to the size already in the IOI). In some embodiments, setting the size can include rounding the size determined at 208, adjusting the size determined at 208 for a minimum or maximum, allocating the size determined at 208 across multiple IOIs, etc.

Process 200 can next determine whether there are any other IOIs for the order's symbol and side at 218. If there are other IOIs, then process 200 can select the next IOI at 220 and loop back to 216. Otherwise, process 200 can select the next order in the book at 212 and loop back to 206.

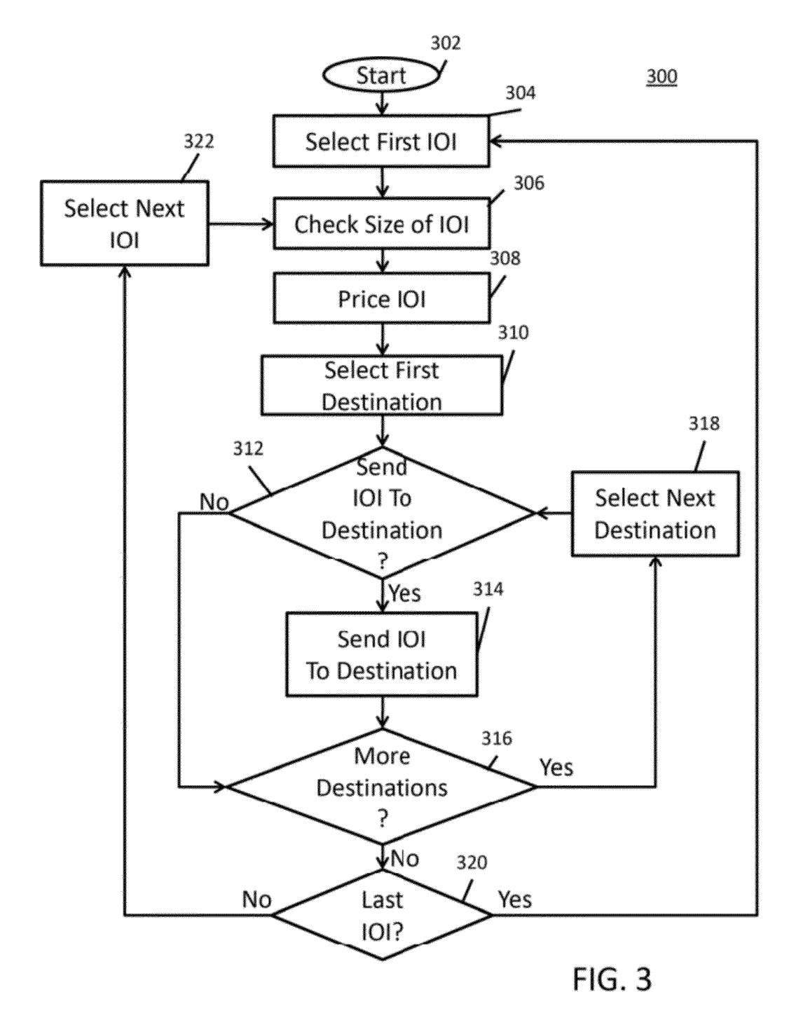

Turning to FIG. 3, an example process 300 for sending IOIs to one or more destinations is shown. Such a process can be executed in IOI server 108 of FIG. 1. As illustrated, after process 300 begins at 302, the process can select a first IOI at 304. The IOI can be selected on any suitable basis. For example, the IOI can be selected based on age, symbol, size, side, etc.

The process next checks the size of the IOI at 306 and makes any suitable adjustment. For example, in some embodiments, an absolute limit can be applied to the size of an IOI such that its size can never be greater than the sum of the parent leaves of all of the included orders. As another example, the size of an IOI can be rounded based on factors including the ADV for the symbol, the number of orders, a system-wide rounding limit, and the state of any orders in the IOI which have been set manually. As yet another example, the size of an IOI can be rounded to ensure that the size for an IOI is large enough to warrant an IOI being distributed.

Next, at 308, the price associated with an IOI can be determined. Any suitable approach for pricing an IOI can be used in some embodiments. For example, real time market data can be used to determine a price used in an IOI. As a more particular example, in some embodiments, an IOI can be priced at the mid-point of the National Best Bid and Offer (NBBO), at some other point within the NBBO, etc.

Process 300 can then determine the destinations to which the IOI is to be sent and send the IOI to those destinations. In doing so, the process can select a first possible destination to which to send the IOI at 310. This possible destination can be selected on any suitable basis. For example, this destination can be selected based on name, rank (based on any suitable comparison of destinations), volume transacted, etc.

At 312, process 300 can determine whether to send the current IOI to the current destination. Any suitable process for making this determination can be used in some embodiments. For example, in some embodiments, IOIs can be prevented from being sent to a party that has an active order for the same symbol and side—e.g., do not send an IOI to buy IBM if a client has an active order to buy IBM. For example, such parties that may be blocked from receiving an IOI can include parties whose orders are the basis for the IOI. As another example, a destination may be determined as being ready to receive an IOI when there has been a significant change in the size of the IOI (e.g., based on a threshold, which can be global, destination specific, symbol specific, based on size, based on value (e.g., size multiplied by price), etc.), when a certain period of time period has passed since an IOI for the same symbol and side has been sent to the destination (e.g., which time period can be set globally, set based on a destination, set based on volume, etc.), etc.

If it is determined that the current IOI is to be sent to the current destination, then process 300 can send the IOI to the destination at 314. The IOI can be sent to the destination using any suitable technique, such as by sending the IOI to the destination as a Financial Information eXchange (FIX) protocol message.

After sending the IOI, or if it is determined that the current IOI is not to be sent to the current destination, then process 300 can determine whether there are any other possible destinations at 316. If there are other destinations, then process 300 can select the next destination at 318 and loop back to 312. As with selecting the first possible destination at 310, selecting the next destination at 318 can be performed on any suitable basis.

If it is determined at 316 that there are no other destinations, however, then process 300 can determine at 320 if the current IOI is the last IOI. If the current IOI is not the last IOI, then process 300 can select the next KM at 322. As with selecting the first IOI at 304, selecting the next IOI at 322 can be performed on any suitable basis. If the current IOI is the last IOI, however, then process 300 can loop back to 304 and select the first IOI as the current IOI.

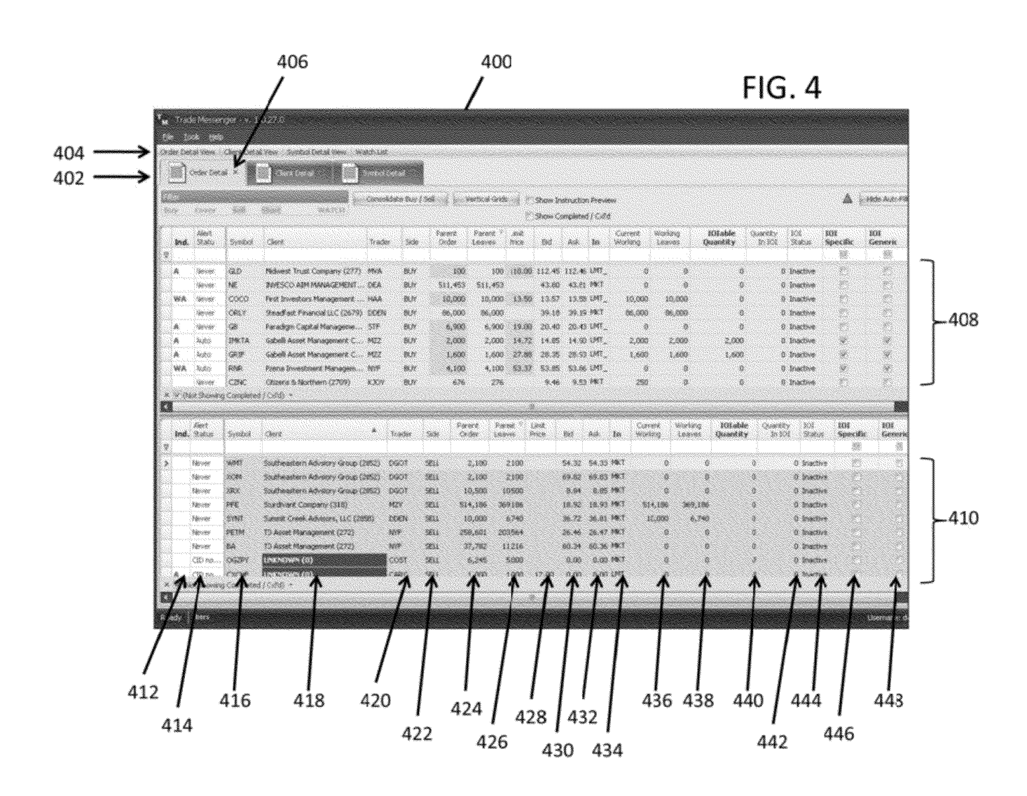

FIG. 4 illustrates an example user interface 400 for controlling the generation of IOIs based on orders in accordance with some embodiments. Such an interface can be displayed on the displays 110 and 114 of FIG. 1. As shown, interface 400 includes buttons 404 to control what tabs 402 are displayed to a user. Buttons 404 can include an order detail view button, a client detail view button, a symbol detail view button, a watch list button, and/or any other suitable buttons. Tabs 402 can include any suitable tabs, such as an order detail tab, a client detail tab, a symbol detail tab, and/or any other suitable tabs.

An example of an order detail tab 406 is illustrated in FIG. 4. As shown, this tab includes a buy portion 408 and a sell portion 410. Portions 408 and 410 can include an “Ind.” column 412, an “Alert Status” column 414, a “Symbol” column 416, a “Client” column 418, a “Trader” column 420, a “Side” column 422, a “Parent Order” column 424, a “Parent Leaves” column 426, a “Limit Price” column 428, a “Bid” column 430, an “Ask” column 432, an “Instruction” column 434, a “Current Working” column 436, a “Working Leaves” column 438, an “IOIable Quantity” column 440, a “Quantity In IOI” column 442, an “IOI status” column 444, an “IOI specific” column 446, an “IOI generic” column 448, and/or any other suitable columns. Buy portion 408 and sell portion 410 are illustrated as including the same columns, however, these portions can include different columns in some embodiments.

“Ind.” column 412 can be used to indicate a status or special condition that applies to the treatment of an order. For example, an “A” can be indicated for a limit order out of market, a “W” can be indicated for an order on a trader's watch list, etc.

“Alert Status” column 414 can be used to designate and indicate that an order is to be included (e.g., with the entry “Auto”) or not included (e.g., with the entry “Never”) in IOIs (e.g., at 206 of FIG. 2). Other entries in column 414 can additionally or alternatively be used (e.g., “Man” to indicate that a manual size entry is to be used for an IOI, “ADV Alerted” to indicate that the order size is above an ADV threshold for the security, etc.).

“Symbol” column 416 can be used to indicate a symbol of the security corresponding to an order.

“Client” column 418 can be used to indicate the identity of the party that is seeking to execute a trade based on the order.

“Trader” column 420 can be used to indicate the identity of a trader responsible for executing a trade based on the order.

“Side” column 422 can be used to indicate whether the order is to buy or sell securities.

“Parent Order” column 424 can be used to indicate the total size corresponding to the order in shares of the specified security.

“Parent Leaves” column 426 can be used to indicate the number of unexecuted shares corresponding to the order.

“Limit Price” column 428 can be used to indicate a limit price that has been specified for the order. When the limit price is highlighted (e.g., with a gray background), this can be used to indicate that the price is out of the market.

“Bid” column 430 can be used to indicate the current bid price for the symbol corresponding to the order in the open markets.

“Ask” column 432 can be used to indicate the current ask price for the symbol corresponding to the order in the open markets.

“Instruction” column 434 can be used to indicate what type of order an order is—e.g., a limit order, a market order, etc.—, any special instructions on how an order should be managed, etc.

“Current Working” column 436 can be used to indicate the size of the current slice(s) of the order that are being worked (i.e., trying to be bought or sold (as the case may be)) and to determine the size of an order to be included in an IOI (e.g., at 208 of FIG. 2).

“Working Leaves” column 438 can be used to indicate the size of the current slice(s) of the order that have not yet been executed.

“IOIable Quantity” column 440 can be used to designate (when the size for an IOI is indicated manually) or indicate (when the size for an IOI is generated automatically) the size of an order to be included in one or more IOI(s).

“Quantity In IOI” column 442 can be used to indicate the size of the order that is included in an IOI being sent to destinations.

“IOI status” column 444 can be used to indicate whether an IOI is active. In some embodiments, an IOI can automatically expire (and thus become inactive) after a specified period of time (e.g., five minutes).

“IOI specific” column 446 can be used to indicate that an IOI is for a specific quantity.

“IOI generic” column 448 can be used to indicate that an IOI is sent for an unspecified quantity, but is “large,” “medium,” “small,” etc.

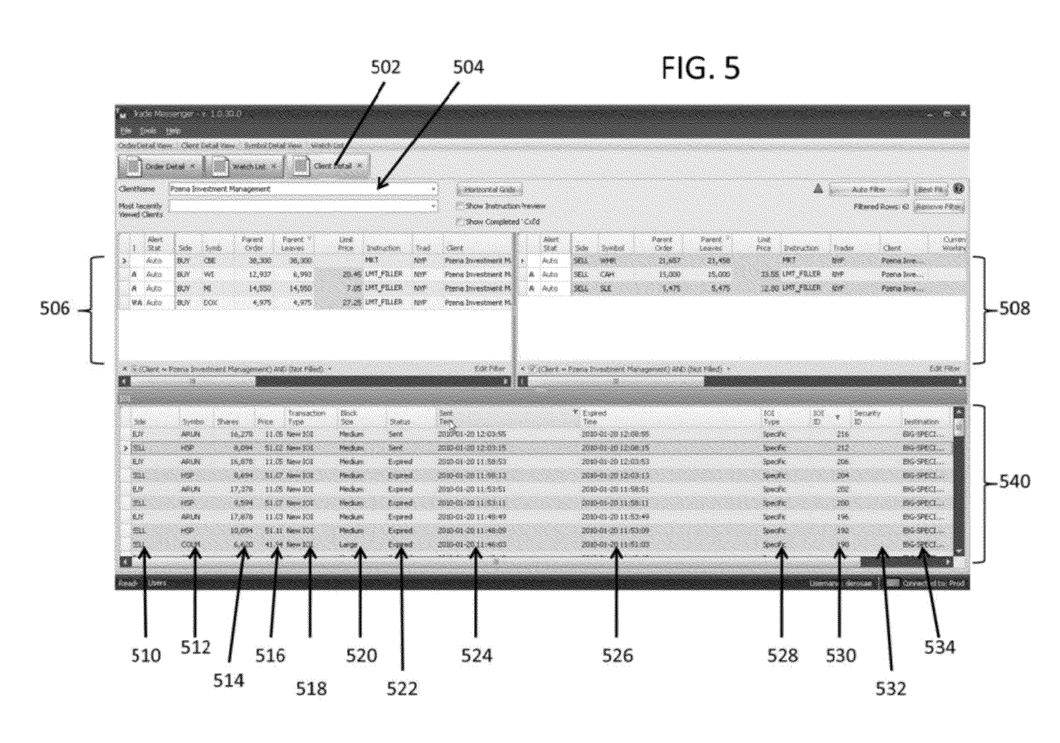

FIG. 5 illustrates a client tab 502 that can be used in conjunction with interface 400 of FIG. 4 in some embodiments. As shown, tab can include a buy portion 506 and a sell portion 508. These portions of tab 502 can include some or all of the columns as included in portions 408 and 410 of FIG. 4, as described above, in accordance with some embodiments.

Tab 502 can also include a portion 540 for displaying information on IOIs being generated (e.g., IOIs being sent to destinations at 314 of FIG. 3). As shown, portion 540 includes a “Side” column 510, a “Symbol” column 512, a “Shares” column 514, a “Price” column 516, a “Transaction Type” column 518, a “Block Size” column 520, a “Status” column 522, a “Sent Time” column 524, an “Expired Time” column 526, an “IOI Type” column 528, an “IOI ID” column 530, a “Security ID” column 532, a “Destination” column 534, and/or any other suitable columns.

“Side” column 510 can be used to indicate the side of an IOI—that is whether the IOI indicates in interest to buy or sell a security.

“Symbol” column 512 can be used to indicate the symbol of the security corresponding to the IOI.

“Shares” column 514 can be used to indicate the size of the IOI.

“Price” column 516 can be used to indicate the price indicated in the IOI.

“Transaction Type” column 518 can be used to indicate that the IOI is a new IOI or to cancel an IOI.

“Block Size” column 520 can be used to indicate the IOI size.

“Status” column 522 can be used to indicate that an IOI has been sent, has expired, etc.

“Sent Time” column 524 can be used to indicate the date and time at which an IOI was sent.

“Expired Time” column 526 can be used to indicate the date and time at which an IOI expired.

“IOI Type” column 528 can be used to indicate the type of IOI. For example, “specific” can be used to indicate that the IOI indicates a specific size and “generic” can be used to indicate that the IOI indicates only a general range of size.

“IOI ID” column 530 can be used to indicate an identifier (e.g., an identification number) for the IOI.

“Security ID” column 532 can be used to indicate the name of a security the IOI is for. For example, for domestic securities, the Security ID is usually a ticker and, for international securities, the Security ID is usually SEDOL or ISIN.

“Destination” column 534 can be used to indicate the destination to which an IOI was sent.

IOI server 108 may be implemented using any suitable hardware and/or software. For example, IOI server 108 may be implemented in any one or more general purpose device, such as a computer, or a special purpose device, such as a client, a server, etc., using any suitable software for performing any suitable combination, set, and/or subset of the functions described herein. Any of these general or special purpose devices can include any suitable components such as a hardware processor (which can be a microprocessor, digital signal processor, a controller, etc.), memory, communication interfaces, display controllers, input devices, etc.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

What is claimed is:

1. A system for generating and sending indications of interest in trading systems, comprising:
at least one hardware processor that:
determines whether an order is blocked from inclusion in an indication of interest;
determines whether the order is marketable;
generates the indication of interest so that it includes at least a portion of the order when the order is determined to not be blocked and the order is marketable;
determines whether the indication of interest is blocked from being sent to a destination; and
sends the indication of interest to the destination when the indication of interest is determined to not be blocked from being sent to the destination.

2. The system of claim 1, wherein the at least one hardware processor also receives the order from at least one of an order management system, an automated trade generation system, and an order entry system.

3. The system of claim 1, wherein the order is a slice of a larger order.

4. The system of claim 1, wherein the order is determined to be blocked from inclusion in the indication of interest based on at least one of a symbol, a side, and a party of the order.

5. The system of claim 1, wherein the at least one hardware processor also determines a size of the order to be included in the indication of interest.

6. The system of claim 5, wherein the size is based on a current working quantity of the order.

7. The system of claim 1, wherein the order is determined to be blocked from inclusion in the indication of interest based on a time threshold associated with the order.

8. The system of claim 1, wherein the at least one hardware processor also selects the indication of interest from a plurality of indications of interest being generated.

9. The system of claim 8, wherein the indication of interest is selected from the plurality of indications of interest based on at least one of a symbol and a side of the indication of interest.

10. The system of claim 1, wherein the order is determined to be blocked based on at least one of: a party associated with the destination having an active order for the same symbol and the same side as the indication of interest; there not having been a significant change in the size of the indication of interest since the last indication of interest for the same symbol and the same side as the indication of interest that was sent to the destination; and there not having been a large enough period of time having passed since the last indication of interest for the same symbol and the same side as the indication of interest that was sent to the destination.

11. A method for generating and sending indications of interest in trading systems, comprising:
determining, using at least one hardware processor, whether an order is blocked from inclusion in an indication of interest;
determining, using at least one hardware processor, whether the order is marketable;
generating, using at least one hardware processor, the indication of interest so that it includes at least a portion of the order when the order is determined to not be blocked and the order is marketable;
determining, using at least one hardware processor, whether the indication of interest is blocked from being sent to a destination; and
sending, using at least one hardware processor, the indication of interest to the destination when the indication of interest is determined to not be blocked from being sent to the destination.

12. The method of claim 11, further comprising receiving the order from at least one of an order management system, an automated trade generation system, and an order entry system.

13. The method of claim 11, wherein the order is a slice of a larger order.

14. The method of claim 11, wherein the order is determined to be blocked from inclusion in the indication of interest based on at least one of a symbol, a side, and a party of the order.

15. The method of claim 11, further comprising determining a size of the order to be included in the indication of interest.

16. The method of claim 15, wherein the size is based on a current working quantity of the order.

17. The method of claim 11, wherein the order is determined to be blocked from inclusion in the indication of interest based on a time threshold associated with the order.

18. The method of claim 11, further comprising selecting the indication of interest from a plurality of indications of interest being generated.

19. The method of claim 18, wherein the indication of interest is selected from the plurality of indications of interest based on at least one of a symbol and a side of the indication of interest.

20. The method of claim 11, wherein the order is determined to be blocked based on at least one of: a party associated with the destination having an active order for the same symbol and the same side as the indication of interest; there not having been a significant change in the size of the indication of interest since the last indication of interest for the same symbol and the same side as the indication of interest that was sent to the destination; and there not having been a large enough period of time having passed since the last indication of interest for the same symbol and the same side as the indication of interest that was sent to the destination.

21. A computer-readable medium containing computer-executable instructions that, when executed by a processor, cause the processor to perform a method for generating and sending indications of interest in trading systems, the method comprising:
determining whether an order is blocked from inclusion in an indication of interest;
determining whether the order is marketable;
generating the indication of interest so that it includes at least a portion of the order when the order is determined to not be blocked and the order is marketable;
determining whether the indication of interest is blocked from being sent to a destination; and
sending the indication of interest to the destination when the indication of interest is determined to not be blocked from being sent to the destination.

22. The medium of claim 21, wherein the method further comprises receiving the order from at least one of an order management system, an automated trade generation system, and an order entry system.

23. The medium of claim 21, wherein the order is a slice of a larger order.

24. The medium of claim 21, wherein the order is determined to be blocked from inclusion in the indication of interest based on at least one of a symbol, a side, and a party of the order.

25. The medium of claim 21, wherein the method further comprises determining a size of the order to be included in the indication of interest.

26. The medium of claim 25, wherein the size is based on a current working quantity of the order.

27. The medium of claim 21, wherein the order is determined to be blocked from inclusion in the indication of interest based on a time threshold associated with the order.

28. The medium of claim 21, wherein the method further comprises selecting the indication of interest from a plurality of indications of interest being generated.

29. The medium of claim 28, wherein the indication of interest is selected from the plurality of indications of interest based on at least one of a symbol and a side of the indication of interest.

30. The medium of claim 21, wherein the order is determined to be blocked based on at least one of: a party associated with the destination having an active order for the same symbol and the same side as the indication of interest; there not having been a significant change in the size of the indication of interest since the last indication of interest for the same symbol and the same side as the indication of interest that was sent to the destination; and there not having been a large enough period of time having passed since the last indication of interest for the same symbol and the same side as the indication of interest that was sent to the destination.
